(19) United States
(12) Patent Application Publication
(10) Pub. No.: US 2016/0149735 A1
(43) Pub. Date: May 26, 2016

(54) RESTORATION OF SIDEBAND SIGNAL

(71) Applicant: QUALCOMM Incorporated, San Diego, CA (US)

(72) Inventors: Angelica WONG, Palo Alto, CA (US); Haitao GAN, Santa Clara, CA (US)

(21) Appl. No.: 14/550,042

(22) Filed: Nov. 21, 2014

(51) Int. Cl. H04L 27/02; H04B 5/00; H04W 4/00

(52) U.S. Cl. CPC H04L 27/02; H04W 4/008; H04B 5/0031

(57) ABSTRACT

Systems and methods relate to extracting a small sideband signal from a received signal having the small sideband with a small frequency offset from a large carrier signal. The received signal is down-converted from a transmission frequency and the large carrier signal is filtered out. A threshold comparator is configured to compare the resultant sideband signal with a first signal threshold and a second signal threshold. If the sideband signal exceeds the first signal threshold in a first direction, the sideband signal is restored to a data signal with a first data value. The restored data signal is retained at the first data value until the sideband signal exceeds a second signal threshold in a second direction, at which time the sideband signal is restored to the data signal with a second data value.

### FIELD OF DISCLOSURE

Disclosed aspects are directed to extraction of sideband signals. More specifically, exemplary aspects related to extraction of sideband signals from a strong carrier signal.

### BACKGROUND

In wireless communication, for example of radio frequency (RF) signals, a data signal is combined with a carrier wave and modulated to a standardized frequency for transmission and reception. This enables the communication to take place at standardized frequencies. The data signal is also known as a sideband signal, and the carrier wave is also known as a carrier signal. During transmission, the sideband or data signal is modulated with the carrier signal in a wireless or RF transmitter. A receiver is configured to receive and demodulate the transmitted signal and extract the data signal.

Some RF communication signals, such as near field communication (NFC) involve a data or sideband signal of much smaller magnitude than the carrier signal. The frequency of the small sideband signal may also be very close to the frequency of the strong carrier signal. The small sideband signal and strong carrier signal are modulated at the transmitter. At the receiver, separating and extracting the sideband signals from the carrier signal is a challenging process.

For example, a conventional RF receiver may involve a mixer to down-convert the received signals. As used herein, the term “down-convert” or “down-converting” refers to converting a signal from a high frequency to a low frequency, such as converting the received signal from the high transmission frequency to the baseband frequency, referred to in the art as a “DC” frequency. A high-pass filter (HPF) may be used to for filtering or rejecting a DC component of the down-converted signal, which pertains to the down-converted carrier signal. The receiver may include additional filters and circuitry such as a low pass filter, an analog-to-digital converter, a demodulator, etc., as known in the art. These components introduce distortions in the sideband signal, whose frequency is close to the frequency of the carrier signal. These distortions make it difficult to correctly detect and extract the data that was carried or represented in the sideband signal. The closeness of the side band signal's frequency to that of the carrier signal may also lead to confusion between the two signals during the detection and extraction process, adding to the difficulty.

Accordingly, there is a need for systems and methods which avoid the aforementioned drawbacks in conventional techniques for detection and extraction of a sideband signal at a receiver.

### SUMMARY

Exemplary aspects include systems and methods for extracting a small sideband signal from a received signal having the small sideband with a small frequency offset from a large carrier signal. The received signal is down-converted from a transmission frequency and the large carrier signal is filtered out. A threshold comparator is configured to compare the resultant sideband signal with a first signal threshold and a second signal threshold. If the sideband signal exceeds the first signal threshold in a first direction, the sideband signal is restored to a data signal with a first data value. The restored data signal is retained at the first data value until the sideband signal exceeds a second signal threshold in a second direction, at which time the sideband signal is restored to the data signal with a second data value.

For example, an exemplary aspect is directed to a method of operating a receiver, the method comprising: comparing a sideband signal with a first signal threshold and a second signal threshold. If the sideband signal exceeds the first signal threshold in a first direction, the sideband signal is restored to a restored data signal with a first data value. The method includes retaining the restored data signal at the first data value until the sideband signal exceeds a second signal threshold in a second direction.

Another exemplary aspect is directed to a receiver comprising a threshold comparator, which is configured to compare a sideband signal with a first signal threshold and a second signal threshold. If the sideband signal exceeds the first signal threshold in a first direction, the threshold comparator is configured to restore the sideband signal to a restored data signal with a first data value and retain the restored data signal at the first data value until the sideband signal exceeds a second signal threshold in a second direction.

Yet another exemplary aspect is directed to an apparatus comprising: means for comparing a sideband signal with a first signal threshold and a second signal threshold, means for restoring the sideband signal to a restored data signal with a first data value if the sideband signal exceeds the first signal threshold in a first direction, and means for retaining the restored data signal at the first data value until the sideband signal exceeds a second signal threshold in a second direction.

### BRIEF DESCRIPTION OF THE DRAWINGS

The accompanying drawings are presented to aid in the description of aspects of the invention and are provided solely for illustration of the aspects and not limitation thereof.

FIGS. 1A-B illustrate an exemplary received signal along with an exemplary receiver for processing the received signal, according to aspects of this disclosure.

FIGS. 2A-C illustrate an exemplary sideband signal along with a threshold comparator and a restored data signal, according to aspects of this disclosure.

FIG. 3 illustrates an exemplary method according to this disclosure.

FIG. 4 illustrates a wireless communication system in which an aspect of this disclosure may be employed.

### DETAILED DESCRIPTION

Aspects of the invention are disclosed in the following description and related drawings directed to specific aspects of the invention. Alternative aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects overcome drawbacks of conventional receivers discussed previously. More particularly, an exemplary receiver may be configured to receive a signal comprising a sideband signal and a carrier signal, and efficiently extract and restore the sideband signal. The sideband signal may be of small magnitude, while the carrier signal may be a strong signal of large magnitude. The sideband signal may have a small frequency offset relative to the carrier signal. These characteristics of a small sideband signal of small frequency offset with a strong carrier signal may pertain to communication signals such as radio frequency (RF) signals and more particularly, near field communication (NFC) signals, although exemplary aspects are not limited to these types of communication signals, and as such, may pertain to any communication signal with similar characteristics.

The exemplary receiver may be configured to down-convert the received signal comprising the sideband signal and the carrier signal to a base band or zero frequency. As previously noted, the down-converted sideband signal may be distorted. Thus, in exemplary aspects, the distortions may be overcome to restore the down-converted sideband signal to a corresponding distortion-free data signal by using two signal threshold values, as follows.

It will be understood that the down-converted sideband signal described in exemplary aspects may be subject to further signal processing which will not be explained at length in this disclosure for the sake of conciseness. For example, a high pass filter (HPF) may be used to filter out the carrier signal such that the down-converted sideband signal remains. Additional components such as a low pass filter, mixer, analog-to-digital converter, etc., may also be provided in the receiver as known in the art. For purposes of this disclosure, the numerous filters and mixers known in the art for receivers (e.g., radio frequency receivers) will be collectively referred to as a “filter.” Thus, the down-converted sideband signal is appropriately filtered to form a down-converted and filtered sideband signal.

Based on characteristics of the receiver, such as sensitivity levels, two signal threshold values are determined—a high signal threshold and a low signal threshold. The high and low signal threshold may be in relation to the DC level. For example, the high signal threshold may be a positive value and the low signal threshold may be a negative value. The high and low signal thresholds may be adjusted or corrected for any DC offsets of the filter as well. In an exemplary receiver, the down-converted and filtered sideband signal is compared to the high and low signal thresholds in the following manner.

Over a course of time starting, for example, at an initial or first time instance, if the down-converted and filtered sideband signal exceeds the high signal threshold, then the sideband signal is restored to a first data value (e.g., a normalized value of “+1”). The restored data signal is retained at the first data value until a second time instance when the down-converted and filtered sideband signal drops below the low signal threshold. At this second time instance, when the down-converted and filtered sideband signal drops below the low signal threshold, the data signal is restored to a second data value (e.g., a normalized value of “−1”). The restored data signal is retained at the second data value until the down-converted and filtered sideband signal once again exceeds the high signal threshold, for example, at a third time instance. At this third time instance, the restored data signal is switched back to the first data value. This process is repeated to generate a restored data signal represented as a square wave.

It will be appreciated that the restored signal is distortion-free in exemplary aspects because, for example, once the data signal is restored to the first data value as above, no further signal comparisons are made with the high signal threshold. The next signal comparison is with the low signal threshold to restore the data signal to the second data value. The reverse is also true, in that, once the data signal has been restored to the second data value, the next comparison is only with the high signal threshold. Thus, it is ensured that any intermediate distortions (e.g., between the first and second time instances above) or spurious signal transitions of the down-converted sideband signal do not cause the restored data to have spikes or distortions introduced. Accordingly, the restored data signal is restored to a clean square wave which is free from distortions.

It will be noted that the above signal comparisons in exemplary aspects may be done continuously in an analog domain or discretely in a digital domain. For digital domain comparisons, an analog-to-digital converter (ADC) may be used to convert the received analog signal to a digital signal, in which case, the signal comparisons may be performed at a sampling frequency of the ADC in the digital domain.

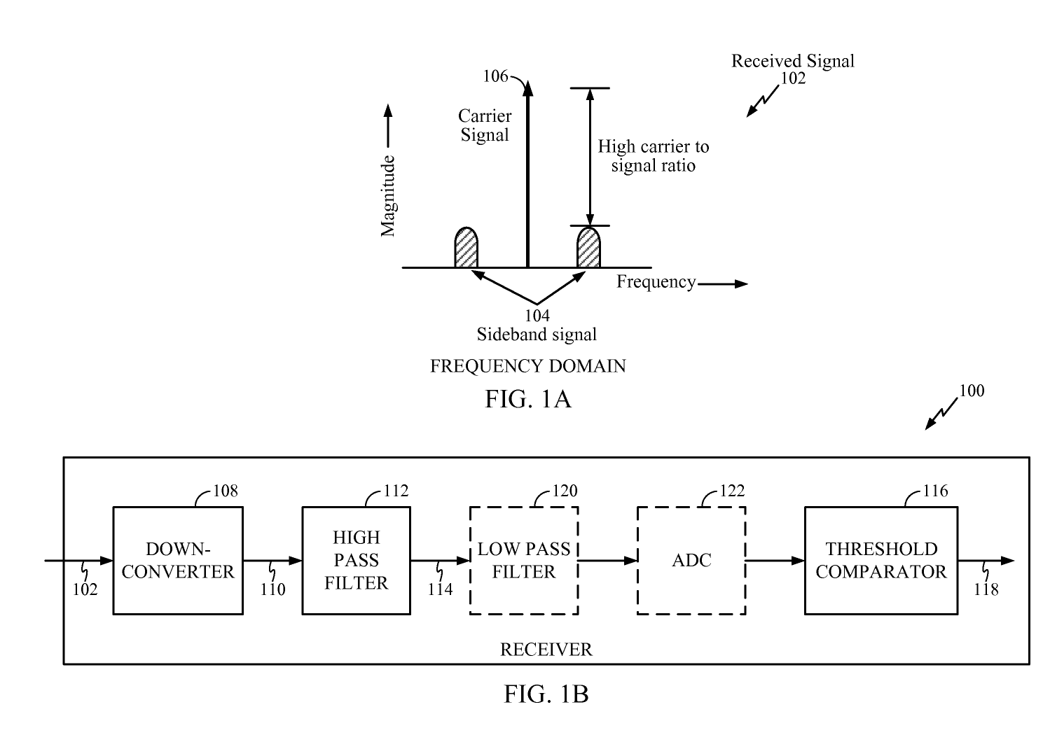

With reference now to FIG. 1A, an example received signal 102 is shown, with frequency domain characteristics. Received signal 102 may include carrier signal 106 and sideband signal 104. Carrier signal 106 may be strong or of high magnitude and sideband signal 104 may be small in comparison, or of lower magnitude. Sideband signal 104 may have a small frequency offset or be of frequency which is close to that of carrier signal 106. Sideband signal 104 may have been modulated to a high transmission frequency (e.g., that of a standard radio frequency) by a transmitter (not shown), wherein the high transmission frequency may correspond to the frequency of carrier signal 106.

With reference to FIG. 1B, received signal 102 may be received by receiver 100. FIG. 1B shows a schematic of receiver 100 with relevant elements for this disclosure. As previously mentioned, receiver 100 may include various other blocks or components (e.g., as known in the art for RF receivers) which will not be discussed exhaustively herein.

According to aspects of this disclosure, receiver 100 includes down-converter 108, configured to down-convert received signal 102 from transmission frequency to baseband frequency. Down-converter 108 may be implemented with a mixer as known in the art. Down-converted received signal 110 is output from down-converter 108, where down-converted received signal 110 includes a down-converted carrier signal and a down-converted sideband signal (not separately illustrated). High-pass filter 112 filters out the down-converted carrier signal from down-converted received signal 110 to provide down-converted and filtered sideband signal 114. In the case an analog implementation of the exemplary signal comparisons is selected, down-converted and filtered sideband signal 114 is input to threshold comparator 116 to provide restored data signal 118, which is free from distortions according to exemplary aspects. For digital domain implementations, low pass filter 120 and ADC 122 (shown in dashed lines to convey that they are optional components), may be implemented between the output of high-pass filter 112 and threshold comparator 116. The output of ADC 122 will be a digital down-converted and filtered signal which is compared with high and low signal thresholds in the digital domain. As such, the exemplary aspects are applicable to both analog and digital domains, and skilled persons will recognize suitable design variations for analog and digital implementations.

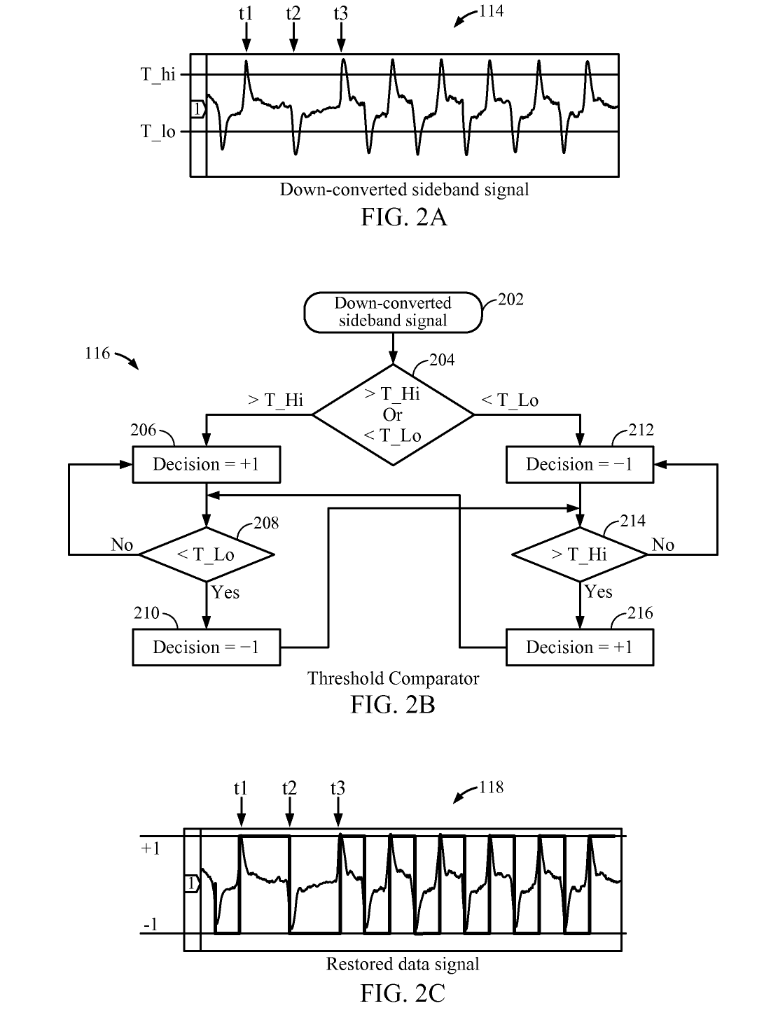

FIGS. 2A-C illustrate exemplary aspects related to obtaining a restored data signal from a sideband signal using threshold comparator 116. Although specific aspects pertain to obtaining restored data signal 118 from down-converted and filtered sideband signal 114, it will be understood that threshold comparator 116 may be more generally used to restore any signal such as a sideband signal without departing from the scope of this disclosure. In other words, down-conversion may not be necessary if the transmission frequency corresponds to the baseband frequency, for example.

First, with reference to FIG. 2A, an example waveform of down-converted and filtered sideband signal 114 in the time domain is illustrated. As shown, down-converted and filtered sideband signal 114 is heavily distorted. The distortion may have occurred due to noise introduced by the various blocks and components of receiver 100, as well as due to the closeness in frequencies of sideband signal 104 and carrier signal 106 in received signal 102. In conventional techniques for restoring the received signals, a down-converted and filtered sideband is compared with a single signal threshold to determine the data output, which can give rise to spurious spikes in a restored data signal.

On the other hand, in exemplary aspects, threshold comparator 116 as shown in FIG. 2B uses two signal thresholds to restore down-converted and filtered sideband signal 114 of FIG. 2A to restored data signal 118 of FIG. 2C. FIG. 2B illustrates a flow-chart or decision flow graph which may be implemented in threshold comparator 116 using appropriate hardware or a combination of hardware and software, for example, based on this disclosure. The decision flow graph of FIG. 2B will now be explained in detail, with combined reference to FIGS. 2A and 2C.

In block 202, down-converted and filtered sideband signal 114 is input to threshold comparator 116. In comparison block 204, down-converted and filtered sideband signal 114 is compared with a first signal threshold in a first direction (e.g., high signal threshold T_Hi) and a second signal threshold in a second direction (e.g., low signal threshold T_Lo). Without loss of generality, the first direction may be a positive direction and the second direction may be a negative direction. Thus if a signal exceeds the first signal threshold in the first direction, the signal is said to be greater than or more positive than the first signal threshold; and if the signal exceeds the second signal threshold in the second direction, then the signal is said to be less than or more negative than the second signal threshold.

Thus in one example, if down-converted and filtered sideband signal 114 is greater than T_Hi, then the process proceeds to block 206. If, on the other hand, down-converted and filtered sideband signal 114 is less than T_Lo, then the process proceeds to block 212, which is similar to the process flow following block 206. The processes and functions related to restoring a sideband signal to a first data value are similar to those pertaining to restoring it to a second data value, and as such, in other examples, the process can begin by first proceeding block 212 rather than block 206.

Accordingly, block 206 may correspond to the first time instance t1, for example, in FIG. 2A, where down-converted and filtered sideband signal 114 is shown to exceed T_Hi. In block 206, the decision is made to restore down-converted and filtered sideband signal 114 to a first data value of “+1,” for example, as shown in FIG. 2C at first time instance t1, where restored data signal 118 is restored to a value of +1.

From block 206, the process proceeds to decision block 208, where down-converted and filtered sideband signal 114 is compared to T_Lo. If down-converted and filtered sideband signal 114 does not fall below T_Lo, the process continues to loop back to block 206, which means that restored data signal 118 stays at the value of +1 until down-converted and filtered sideband signal 114 falls below T_Lo. In this manner, a clean and distortion free signal is obtained. In more detail, since down-converted and filtered sideband signal 114 is not compared with T_Hi immediately following block 206, intermediate fluctuations of down-converted and filtered sideband signal 114 which may deviate from T_Hi will be ignored.

At the second time instance t2, for example it is seen that down-converted and filtered sideband signal 114 falls below T_Lo (see FIG. 2A). Correspondingly, the process illustrated in FIG. 2B exits the loop back to block 206 and enters block 210, where a decision is made to restore down-converted and filtered sideband signal 114 to the second data value, “−1,” as shown in FIG. 2C, where restored data signal 118 is set to the value of −1. Once again, it will be appreciated that restored data signal 118 will remain at the value of −1 until yet another comparison of down-converted and filtered sideband signal 114 with T_Hi will yield a +1 data value. From block 210, the process may proceed to block 214.

Considering block 212, the process proceeding from block 212 is similar to the one described above with reference to block 206. Briefly, restored data signal 118 remains at the data value of −1, until the comparison at decision block 214, for example, at the third time instance t3, results in down-converted and filtered sideband signal 114 exceeding T_Hi. At this third time instance t3, restored data signal is once again set to +1 at block 216, where it remains, until the process cycles back, for example, to decision block 208.

Accordingly, it is seen from FIGS. 2A-C that exemplary aspects for restoring down-converted sideband signal 114 to restored data signal 118 only involve comparisons with the two signal thresholds. The two signal thresholds can be adjusted or corrected for any DC offset of the filters in receiver 100. This means that time consuming and power hungry computations related to subtractions or shifts to a DC offset of each sample will not be required. Thus, path delays are minimized Further, as seen, distortions are eliminated to provide a clean and distortion-free restored data signal 118.

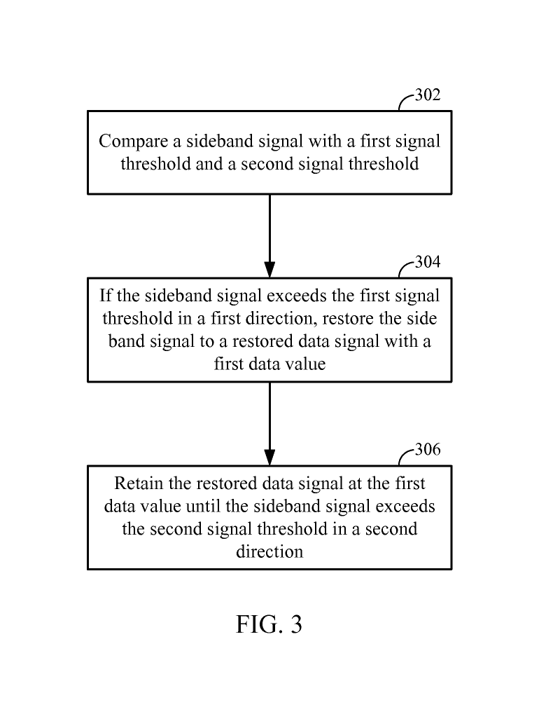

In addition to the above-described aspects, it will be appreciated that exemplary aspects can include various methods for performing the processes, functions, or algorithms disclosed herein. For example, as illustrated in FIG. 3, an exemplary aspect can include a method of signal processing (e.g., at receiver 100), the method comprising: comparing a sideband signal (e.g., 114) with a first signal threshold (e.g., T_Hi) and a second signal threshold (e.g., T_Lo)—Block 302; if the sideband signal exceeds the first signal threshold in a first direction (e.g., at time t1), restoring the side band signal to a restored data signal (e.g., 118) with a first data value (e.g., +1)—Block 304; and retaining the restored data signal at the first data value until the sideband signal exceeds the second signal threshold in a second direction (e.g., at time t2)—Block 306. In further aspects not illustrated in this figure, when the sideband signal exceeds the second signal threshold in the second direction, the side band signal may be restored to the restored data signal with a second data value and retained at the second data value until the sideband signal exceeds the first signal threshold in the first direction.

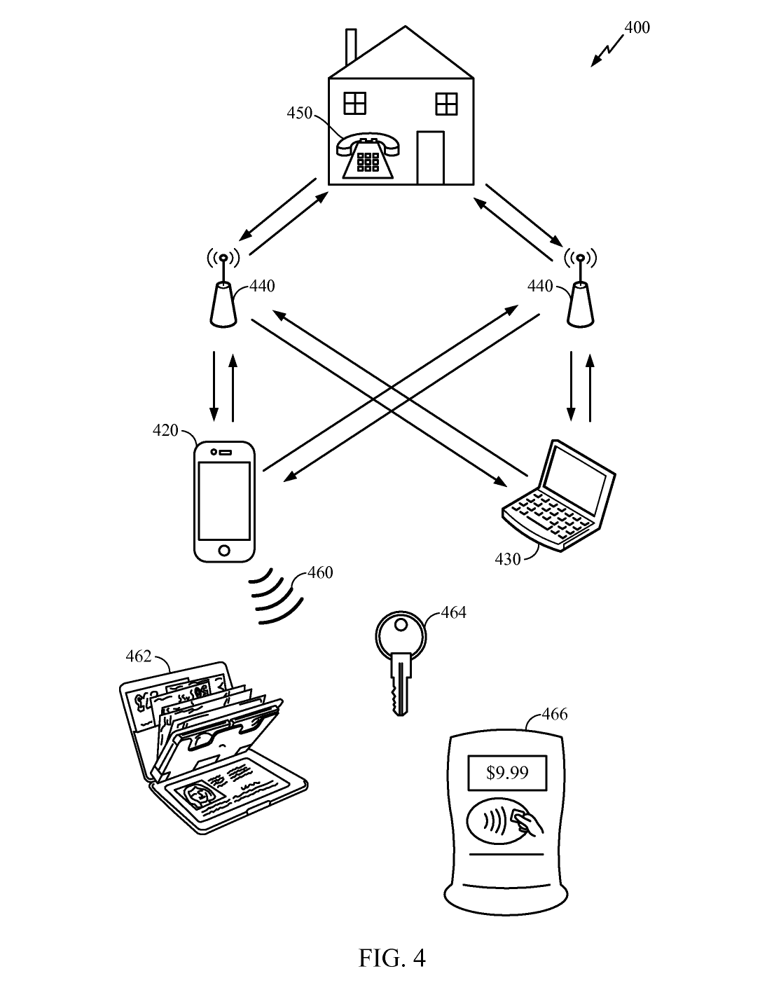

FIG. 4 illustrates an exemplary wireless communication system 400 in which an aspect of the disclosure may be advantageously employed. For purposes of illustration, FIG. 4 shows three remote units 420, 430, and 450 and two base stations 440. In FIG. 4, remote unit 420 is shown as a mobile telephone, remote unit 430 is shown as a portable computer, and remote unit 450 is shown as a fixed location remote unit in a wireless local loop system. For example, the remote units may be mobile phones, hand-held devices, personal communication devices, portable data units such as personal data assistants, GPS enabled devices, navigation devices, set-top boxes, music players, video players, entertainment units, fixed location data units such as meter reading equipment, or any other device or computer that stores or retrieves data or computer instructions, or any combination thereof.

As shown, remote unit 420, for example, may be configured for radio frequency (RF) communication to send and receive signals such as received signal 102 comprising carrier signal 106 and sideband signal 104 described in exemplary aspects above. In one example, the RF communication may pertain to near-field communication (NFC) 460 with small sideband signal having a small frequency offset from a large carrier signal. Remote unit 420 may communicate with NFC or any other RF communication 460 with NFC capable or NFC enabled objects such as credit cards or other sources of payment carried in a user's wallet 462, key 464 with radio frequency identification (RFID), NFC enabled payment portal 466, etc.

Although FIG. 4 illustrates remote units according to the teachings of the disclosure, the disclosure is not limited to these exemplary illustrated units. Aspects of the disclosure may be suitably employed in any device which includes active integrated circuitry including memory and on-chip circuitry for test and characterization.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of aspects of this disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method of signal processing for restoring a small frequency offset small sideband signal from a large carrier signal. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of operating a receiver, the method comprising:
comparing a sideband signal with a first signal threshold and a second signal threshold;
if the sideband signal exceeds the first signal threshold in a first direction, restoring the sideband signal to a restored data signal with a first data value; and
retaining the restored data signal at the first data value until the sideband signal exceeds a second signal threshold in a second direction.

2. The method of claim 1 further comprising:
when the sideband signal exceeds the second signal threshold in the second direction, restoring the sideband signal to the restored data signal with a second data value; and
retaining the restored data signal at the second data value until the sideband signal exceeds the first signal threshold in the first direction.

3. The method of claim 2, wherein the first signal threshold is a high signal threshold and the first direction is positive; and the second signal threshold is a low signal threshold and the second direction is negative.

4. The method of claim 1, comprising obtaining the sideband signal from a received signal comprising the sideband signal and a carrier signal, wherein the sideband signal is small in magnitude in comparison with the carrier signal and has a small frequency offset from the carrier signal.

5. The method of claim 4, wherein the obtaining the sideband signal comprises down-converting the received signal from a transmission frequency to a baseband frequency and filtering out the carrier signal.

6. The method of claim 4, wherein the received signal is a radio frequency (RF) signal.

7. The method of claim 6, wherein the RF signal is a near-field communication (NFC) signal.

8. A receiver comprising:
a threshold comparator configured to:
compare a sideband signal with a first signal threshold and a second signal threshold;
restore the sideband signal to a restored data signal with a first data value if the sideband signal exceeds the first signal threshold in a first direction; and
retain the restored data signal at the first data value until the sideband signal exceeds a second signal threshold in a second direction.

9. The receiver of claim 8, wherein the threshold comparator is further configured to:
restore the sideband signal to the restored data signal with a second data value when the sideband signal exceeds the second signal threshold in the second direction, and
retain the restored data signal at the second data value until the sideband signal exceeds the first signal threshold in the first direction.

10. The receiver of claim 9, wherein the first signal threshold is a high signal threshold and the first direction is positive; and the second signal threshold is a low signal threshold and the second direction is negative.

11. The receiver of claim 8 comprising:
a down-converter configured to down-convert a received signal comprising the sideband signal and a carrier signal from a transmission frequency to a baseband frequency; and
a filter configured to filter out the carrier signal from the down-converted received signal.

12. The receiver of claim 11, wherein the sideband signal is small in magnitude in comparison to the carrier signal and has a small frequency offset from the carrier signal.

13. The receiver of claim 11, wherein the received signal is a radio frequency (RF) signal.

14. The receiver of claim 13, wherein the RF signal is a near-field communication (NFC) signal.

15. The receiver of claim 8 integrated in a device, selected from the group consisting of a set-top box, music player, video player, entertainment unit, navigation device, communications device, personal digital assistant (PDA), fixed location data unit, and a computer.

16. An apparatus comprising:
means for comparing a sideband signal with a first signal threshold and a second signal threshold;
means for restoring the sideband signal to a restored data signal with a first data value if the sideband signal exceeds the first signal threshold in a first direction; and
means for retaining the restored data signal at the first data value until the sideband signal exceeds a second signal threshold in a second direction.

17. The apparatus of claim 16 further comprising:
means for restoring the sideband signal to the restored data signal with a second data value when the sideband signal exceeds the second signal threshold in the second direction; and
means for retaining the restored data signal at the second data value until the sideband signal exceeds the first signal threshold in the first direction.

18. The apparatus of claim 17, wherein the first signal threshold is a high signal threshold and the first direction is positive; and the second signal threshold is a low signal threshold and the second direction is negative.

19. The apparatus of claim 16, further comprising:
means for down-converting a received signal comprising the sideband signal and a carrier signal from a transmission frequency to a baseband frequency; and
means for filtering out the carrier signal from the down-converted received signal.

20. The apparatus of claim 19, wherein the sideband signal is small in magnitude in comparison to the carrier signal and has a small frequency offset from the carrier signal.
